(19) United States
(12) Patent Application Publication
(10) Pub. No.: US 2008/0134102 A1
(43) Pub. Date: Jun. 5, 2008

(54) METHOD AND SYSTEM FOR DETECTING MOVEMENT OF AN OBJECT

(75) Inventors: Cathrine Movold, Lund (SE); Marten A. Jonsson, Malmo (SE); Lars D. Mauritzson, Malmo (SE); Gunnar Klinghult, Lund (SE); Johanna L. Meiby, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/766,316

(22) Filed: Jun. 21, 2007

Related U.S. Application Data
(60) Provisional application No. 60/868,660, filed on Dec. 5, 2006.

(51) Int. Cl. G06F 3/033

(52) U.S. Cl. 715/863

(57) ABSTRACT

A system, method and computer application for electronic equipment 10 having a contact-less user input device that is capable of detecting and/or sensing user movement (e.g., gestures) and controlling one or more parameters associated with the electronic equipment and/or being executed on the electronic equipment based at least in part on the detected and/or sensed user movement is disclosed. A predetermined movement may be detected by the movement detection circuitry (e.g., camera, infrared sensors, etc.) and a corresponding user controllable feature or parameter of the electronic equipment and/or application program may be controlled based upon the detected predetermined movement. The controllable feature may vary based upon the type of application being executed by the electronic equipment and velocity and/or acceleration of the object being detected.

### RELATED APPLICATION DATA

This application claims the benefit of U.S. Provisional Application No. 60/868,660 filed Dec. 5, 2006, which is incorporated herein by reference.

### TECHNICAL FIELD OF THE INVENTION

The present invention relates to a contact-less user interface for electronic equipment that is capable of detecting movement of an object and controlling one or more parameters associated with the electronic equipment and/or applications executed on the electronic equipment based at least in part on the detected movement of the object.

### DESCRIPTION OF THE RELATED ART

Electronic equipment, such as, for example, communication devices, mobile phones, personal digital assistants, etc. are typically equipped to communicate over cellular telephone communication networks. Such electronic equipment generally includes one or more user input devices. Common input devices include, for example, a computer mouse, a track ball, a touchpad, etc. The computer mouse is widely popular as a position indicating device. The computer mouse generally requires a surface upon which to roll or otherwise move a position sensor. The computer mouse translates movement of the position sensor across a surface as input to a computer. The growing popularity of laptop or notebook computers has created a significant problem for mouse type technologies that require a rolling surface. Laptop computers are inherently portable and designed for use in small confined areas such as, for example, airplanes, where there is insufficient room for a rolling surface. Adding to the problem is that a mouse usually needs to be moved over long distances for reasonable resolution. Finally, a mouse requires the user to lift a hand from the keyboard to make the cursor movement, thereby disrupting and/or otherwise preventing a user from periodically typing on the computer.

As a result of the proliferation of laptop computers, a trackball was developed. A track ball is similar to a mouse, but does not require a rolling surface. A track ball is generally large in size and does not fit well in a volume-sensitive application such as a laptop computers or other small and/or portable electronic equipment.

A computer touchpad was also developed. A conventional computer touchpad is a pointing device used for inputting coordinate data to computers and computer-controlled devices. A touchpad is typically a bounded plane capable of detecting localized pressure on its surface. A touchpad may be integrated within a computer or be a separate portable unit connected to a computer like a mouse. When a user touches the touchpad with a finger, stylus, or the like, the circuitry associated with the touchpad determines and reports to the attached computer the coordinates or the position of the location touched. Thus, a touchpad may be used like a mouse as a position indicator for computer cursor control.

There are drawbacks associated with user interfaces that require physical contact. Such drawbacks include, densely populated user interfaces, difficult manipulation of the user interface due to physical size limitation of electronic equipment, difficult for users to view and/or otherwise manipulate densely populated user interfaces, etc.

### SUMMARY

In view of the aforementioned shortcomings associated with user input devices, there is a strong need in the art for a contact-less user interface and an associated algorithm in electronic equipment that is capable of detecting and/or sensing user movement (e.g., gestures). Once detected, the user movement may be used to control a wide variety of parameters associated with the electronic equipment and/or other electronic equipment.

A predetermined movement may be detected by user input circuitry and a corresponding user controllable feature or parameter of the electronic equipment and/or application program may be controlled based upon the detected predetermined movement. The controllable feature may vary based upon the type of application being executed by the electronic equipment. Exemplary types of features associated with electronic equipment that may be controlled using the user input circuitry include: raising and/or lowering speaker volume associated with the electronic equipment; dimming and/or raising the illumination of a light and/or display associated with the electronic equipment; interacting with a graphical user interface (e.g., by moving a cursor and/or an object on a display associated with the electronic equipment, turning electronic equipment on and/or off; control multimedia content being played on the electronic equipment (e.g., by skipping to next or previous track based upon the detected user movement), touch to mute applications, detecting surfaces for playing games, detecting other electronic equipment for playing games, sharing multimedia and/or other information, etc.

One aspect of the invention relates to an electronic equipment comprising: movement detection circuitry configured to detect movement of an object near the movement detection circuitry, wherein the movement detection circuitry includes at least one sensor and generates at least one output signal corresponding to a position of the object detected; a processor coupled to the movement detection circuitry, wherein the processor receives one or more signals from the movement detection circuitry and outputs a control signal based at least in part on the one or more signals detected by the movement detection circuitry.

Another aspect of the invention relates to the movement detection circuitry being a camera.

Another aspect of the invention relates to the sensors being image sensors.

Another aspect of the invention relates to the sensors are at least one selected from the group consisting of: charge-coupled devices (CCD) or complementary metal-oxide-semiconductor (CMOS) sensors.

Another aspect of the invention relates to a memory coupled to the processor for storing the at least one output signal corresponding to the detected movement of the object.

Another aspect of the invention relates to a movement detection algorithm in the memory for determining movement information corresponding to the position of the object detected by the movement detection circuitry.

Another aspect of the invention relates to the movement detection algorithm compares the at least one output signal from the movement detection circuitry at a first time period and the at least one output signal from the movement detection circuitry at a second time period.

Another aspect of the invention relates to the output signal from the first and second time period is in the form of image data.

Another aspect of the invention relates to a housing that houses the processor and at least a portion of the movement detection circuitry.

Another aspect of the invention relates to the at least one sensor is located on an outer surface of the housing.

Another aspect of the invention relates to the movement detection circuitry includes a plurality of sensors.

Another aspect of the invention relates to at least one of the sensors is an infrared sensor.

Another aspect of the invention relates to the movement detection circuitry detects movement in a target field near the electronic equipment.

Another aspect of the invention relates to a memory coupled to the processor for storing the at least one output signal corresponding to the detected movement of the object.

Another aspect of the invention relates to a movement detection algorithm in the memory for determining movement information corresponding to the position of the object detected by the movement detection circuitry.

Another aspect of the invention relates to the movement detection algorithm compares the at least one output signal from the movement detection circuitry at a first time period and the at least one output signal from the movement detection circuitry at a second time period.

Another aspect of the invention relates to a housing that houses the processor and at least a portion of the movement detection circuitry.

Another aspect of the invention relates to the at least one sensor is located on an outer surface of the housing.

One aspect of the invention relates to a method for detecting movement near an electronic equipment, the method comprising: providing an electronic equipment including movement detection circuitry disposed within a housing, wherein the movement detection circuitry detects a movement of an object near the electronic equipment and outputs movement information; and processing the movement information received from the movement detection circuitry to generate a control signal based at least in part on the one or more signals received from the movement detection circuitry to control one or more operations of the electronic equipment.

Another aspect of the invention relates to the movement detection circuitry being a camera.

Another aspect of the invention relates to the sensors being image sensors.

Another aspect of the invention relates to the movement detection circuitry detecting a predetermined movement of the object in a target field.

Another aspect of the invention relates to a predetermined output signal being generated based upon a predetermined detected movement.

Another aspect of the invention relates to the predetermined detected movement includes an object moving vertically downward towards the movement detection circuitry.

Another aspect of the invention relates to the vertically downward movement corresponding to generating an output signal to perform at least one function from the group consisting of: decreasing a ring volume associated with an incoming call, reducing volume of a speaker associated with the electronic equipment, or generating a mute operation to mute a ring volume associated with an incoming call, message and/or alert.

Another aspect of the invention relates to the predetermined detected movement includes an object moving vertically upward from the movement detection circuitry.

Another aspect of the invention relates to the vertically upward movement corresponds to generating an output signal to perform at least one function from the group consisting of: increasing a ring volume associated with an incoming call or increasing a volume of a speaker associated with the electronic equipment.

Another aspect of the invention relates to a vertical movement detected by the movement detection circuitry causing a first response when the vertical movement has a first speed and a second response if the vertical movement has a faster relative speed than the first speed.

Another aspect of the invention relates to a horizontal movement detected by the movement detection circuitry causes a first response when the horizontal movement has a first speed and a second response if the horizontal movement has a faster relative speed than the first speed.

Another aspect of the invention relates to a horizontal movement of the object across the electronic equipment detected by the movement detection circuitry controls a snooze alarm function when an alarm is set off.

Another aspect of the invention relates to a horizontal movement of the object across the electronic equipment detected by the movement detection circuitry causes the electronic equipment to skip forward to the next track or backward to the previous track when multimedia content is playing on the electronic equipment depending on detected movement.

Another aspect of the invention relates to the movement detection circuitry detecting an object substantially stationary for a predetermined amount of time and the electronic equipment is in the power save mode, a control signal is generated that activates the electronic equipment from the power save mode.

Another aspect of the invention relates to the movement detection circuitry being a plurality of sensors.

Another aspect of the invention relates to at least one of the sensors is an infrared sensor.

Another aspect of the invention relates to the movement detection circuitry detecting movement in a target field.

One aspect of the invention relates to a computer program stored on a machine readable medium in an electronic equipment, the program being suitable for processing information received from movement detection circuitry to determine movement of an object on near the electronic equipment wherein when the movement detection circuitry determines movement of an object near the electronic equipment, a control signal is generated based at least in part on the detected movement of the object.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”The term “electronic equipment” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1 and 2 are exemplary schematic diagrams illustrating electronic equipment in accordance with aspects of the present invention.

FIG. 3A and 3B is another schematic diagrams illustrating electronic equipment in accordance with aspects of the present invention.

FIGS. 4-8 are various exemplary schematic diagrams illustrating electronic equipment in accordance with aspects of the present invention.

FIG. 9 is a schematic block diagram of an exemplary electronic equipment in accordance with aspects of the present invention.

FIG. 10 is an exemplary cross-sectional view of sensor detection fields in accordance with aspects of the present invention.

FIG. 11 is an exemplary top-view of sensor detection fields in accordance with aspects of the present invention.

FIG. 12 is an exemplary graphical representation of amplitude output from a user input device versus time for horizontal movement detection in accordance with aspects of the present invention.

FIG. 13 is an exemplary graphical representation of amplitude output from a user input device versus time for vertical movement detection in accordance with aspects of the present invention.

FIGS. 14 and 15 are exemplary methods in accordance with aspects of the present invention.

FIG. 16 is a perspective view of an associated user moving on object over movement detection circuitry in a vertical manner in accordance with aspects of the present invention.

FIG. 17 is a perspective view of an associated user moving on object over movement detection circuitry in a horizontal manner in accordance with aspects of the present invention.

FIGS. 18-21 are exemplary methods in accordance with aspects of the present invention.

### DETAILED DESCRIPTION OF EMBODIMENTS

The present invention is directed to electronic equipment 10, sometimes referred to herein as a communication device, mobile telephone, portable telephone, etc., having motion detection circuitry (also referred to herein as user interface circuitry and user input device) that is configured to detect motion and/or movement of an object near the electronic equipment and outputs a signal. The output signal is generally indicative of a location, movement, velocity and/or acceleration of the object without the object necessarily touching the electronic equipment and/or the movement detection circuitry and may be used to control one or more features of the electronic equipment and/or applications being executed on the electronic equipment, including user selectable features.

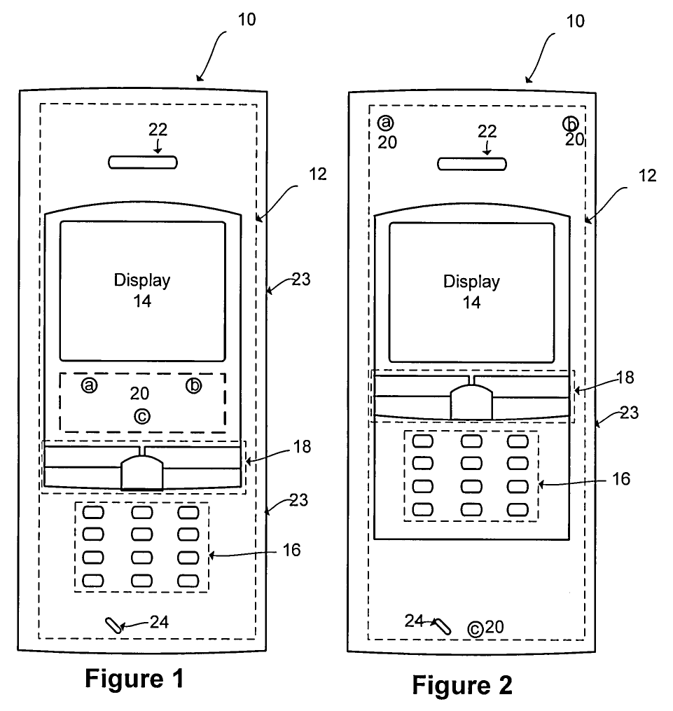

Referring to FIGS. 1 and 2, electronic equipment 10 is shown in accordance with the present invention. The invention is described primarily in the context of a mobile telephone. However, it will be appreciated that the invention is not intended to relate solely to a mobile telephone and can relate to any type of electronic equipment. Other types of electronic equipment that may benefit from aspects of the present invention include personal computers, laptop computers, playback devices, personal digital assistants, alarm clocks, gaming hardware and/or software, etc.

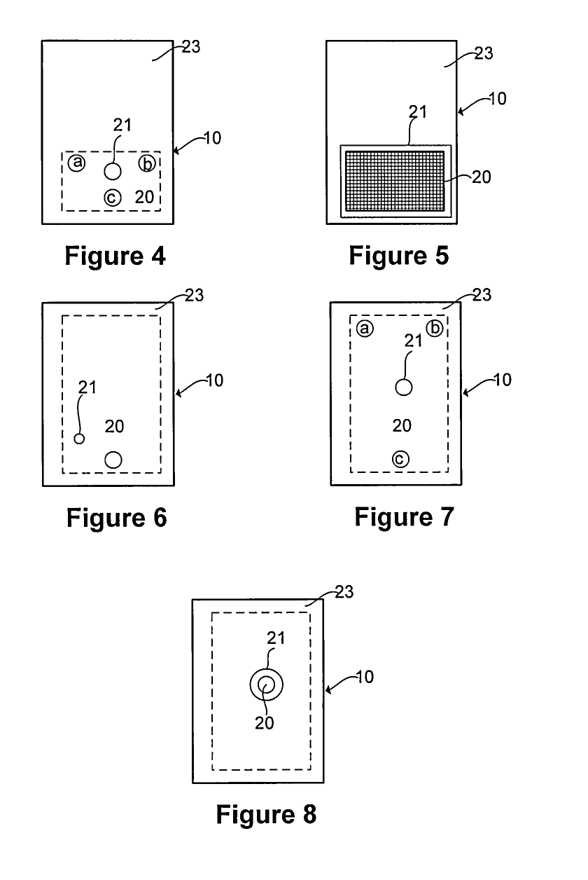

The electronic equipment 10 is shown in FIGS. 1, 2 and 3A-3B as having a “brick” or “block” design type housing, but it will be appreciated that other type housings, such as clamshell housing, as illustrated in FIGS. 4-8, or a slide-type housing may be utilized without departing from the scope of the invention.

As illustrated in FIGS. 1, 2 and 3A-3B, the electronic equipment 10 may include a housing 23 that houses a user interface 12 (identified by dotted lines). The user interface 12 generally enables the user easily and efficiently to perform one or more communication tasks (e.g., identify a contact, select a contact, make a telephone call, receive a telephone call, move a cursor on the display, navigate the display, etc). The user interface 12 (identified by dashed lines) of the electronic equipment 10 generally includes one or more of the following components: a display 14, an alphanumeric keypad 16 (identified by dashed lines), function keys 18, movement detection circuitry 20, one or more light sources 21, a speaker 22, and a microphone 24.

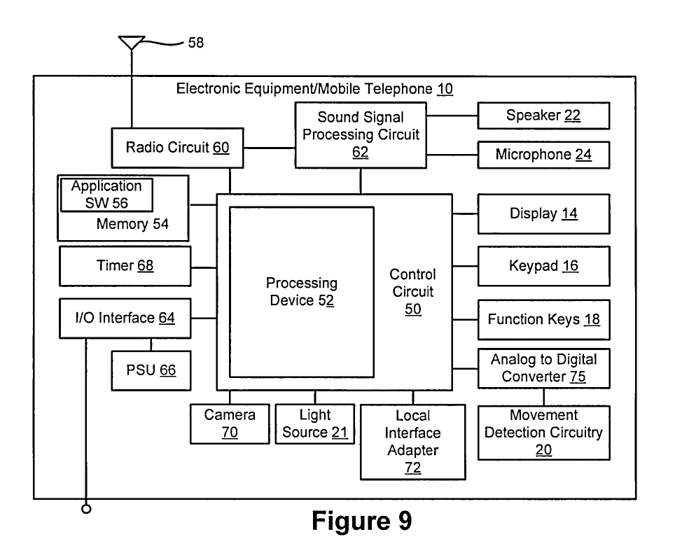

The display 14 presents information to a user such as operating state, time, telephone numbers, contact information, various navigational menus, status of one or more functions, etc., which enable the user to utilize the various features of the electronic equipment 10. The display 14 may also be used to visually display content accessible by the electronic equipment 10. Preferably, the displayed content is displayed in graphical user interface that allows manipulation of objects and/or files by selection of the object and/or file by one or more components of the user interface 12. The displayed content may include graphical icons, bitmap images, graphical images, three-dimensional rendered images, E-mail messages, audio and/or video presentations stored locally in memory 54 (FIG. 9) of the electronic equipment 10 and/or stored remotely from the electronic equipment 10 (e.g., on a remote storage device, a mail server, remote personal computer, etc.). The audio component may be broadcast to the user with a speaker 22 of the electronic equipment 10. Alternatively, the audio component may be broadcast to the user through a headset speaker (not shown).

The electronic equipment 10 further includes a keypad 16 that provides for a variety of user input operations. For example, the keypad 16 may include alphanumeric keys for allowing entry of alphanumeric information such as user-friendly identification of contacts, filenames, E-mail addresses, distribution lists, telephone numbers, phone lists, contact information, notes, etc. In addition, the keypad 16 may include special function keys such as a “call send” key for transmitting an E-mail, initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the electronic equipment 10 may include a volume key, audio mute key, an on/off power key, a web browser launch key, an E-mail application launch key, a camera key, etc. Keys or key-like functionality may also be embodied as a touch screen associated with the display 14.

The movement detection circuitry 20 may be any type of circuitry that is capable of detecting movement of an object without necessarily touching the electronic equipment 10 and/or the movement detection circuitry 20. The movement detection circuitry 20 may be a contact-less sensor, a single sensor, a plurality of sensors and/or an array of sensors. The term movement detection circuitry is intended to be interpreted broadly to include any type of sensor, any number of sensors and/or any arrangement of sensors that is capable of detecting contactless movement of an object over the one or more sensors, unless otherwise claimed. Exemplary sensors include image sensors (e.g., charge-coupled devices (CCD) or complementary metal-oxide-semiconductor (CMOS), infrared sensors (e.g., phototransistors and photodiodes), ultrasonic sensors, electromagnetic sensors, thermal sensors (e.g., heat sensors), location and/or position sensors, etc. In addition, the movement detection circuitry 20 may also be used in combination with a conventional touch sensor (e.g., capacitive touchpad, mouse, touchpad, touch screen, capacitive sensors, etc.), as discussed below.

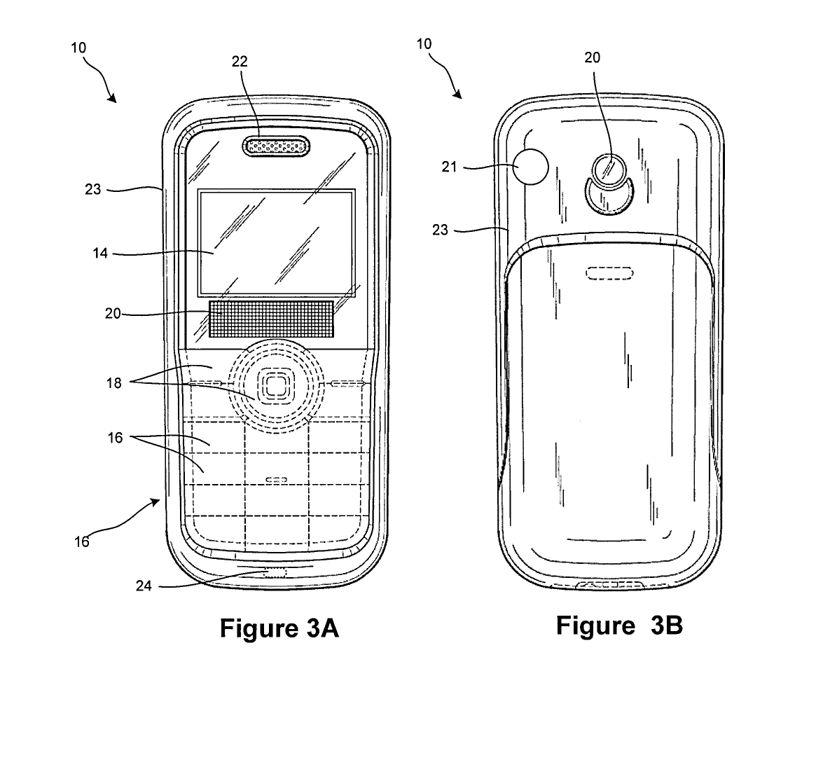

The movement detection circuitry 20 may be located in any desirable position on the electronic equipment 10. The location of the movement detection circuitry 20 may vary based on a number of design considerations. Such design considerations include, for example, the type of sensors used, the number of sensors, the size and shape of the electronic equipment, etc. For example, the movement detection circuitry 20 may be located near the center of the electronic equipment, as shown in FIGS. 1 and 3A, near the perimeter of the housing 23 of the electronic equipment, as shown in FIG. 2, or near an end of the housing 23 of the electronic equipment, as shown in FIG. 3B. In addition, the location of the movement detection circuitry 20 may vary due to the type of electronic equipment in which it is incorporated. For example, if the electronic equipment is an alarm clock, the movement detection circuitry 20 may be located on the top of the alarm clock. Likewise, the user input device may be located on multiple surfaces of the electronic equipment for convenience to the user. This is particularly convenient for the user if the electronic equipment may be used in multiple ways and/or orientations. For example, if the electronic equipment is a portable communications device, the movement detection circuitry 20 may be on the front surface and the back surface of the device.

Referring to FIGS. 4 to 8, an electronic equipment 10 is illustrated having a clamshell housing 23. The movement detection circuitry 20 is generally provided on an outer surface of the housing 23. Based on generally the same design considerations discussed above, the movement detection circuitry 20 may be positioned near on end of the housing 23 (FIGS. 4, 5 and 6), positioned on the outer periphery of the housing 23 (FIG. 7), positioned in the center of the housing 23 (FIG. 8) or any combination of locations on the housing 23.

Likewise, the movement detection circuitry 20 may have any desired number and/or configuration of sensors. For example, a plurality of sensors may be positioned in the shape of a triangle as shown in FIGS. 1, 2, 4 and 7, in the form of a matrix as shown in FIGS. 3A and 5, a single sensor as shown in FIGS. 3B, 6 and 8. Other exemplary configurations include a linear orientation, rectangular orientation, square orientation, polygon orientation, circular orientation, etc. As discussed above, one of ordinary skill in the art will appreciate that the number and configuration of sensors may be a design consideration, functional consideration, and/or an aesthetic consideration.

An exemplary movement detection circuitry 20 in the form of a plurality of sensors in the configuration of a triangle is illustrated in FIGS. 1, 2, 4 and 7. As shown, the movement detection circuitry 20 includes a plurality of sensors (e.g., sensors “a”, “b” and “c”). In this embodiment, three sensors are utilized to obtain movement and/or position data in three dimensions. As discussed below, it may be desirable to use more sensors in order to provide higher precision and provide a more robust system. In addition, it may be desirable to use an image sensor (e.g., a camera) that generally includes a plurality of densely packed sensors to detect movement of an object near an electronic equipment 10.

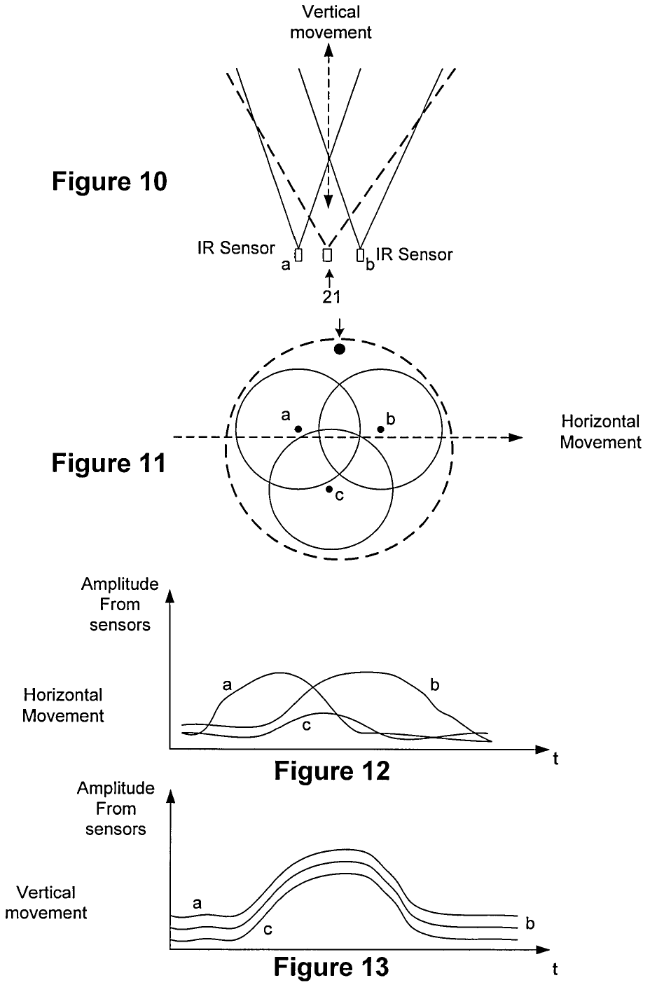

Referring to FIG. 10, a cross-sectional side view of an exemplary output field is illustrated for sensors “a” and “b” (the view for sensor “c” has been omitted for clarity). As shown in FIG. 10, an illumination field (identified by the dashed lines) is provided by the light source 21. The illumination field is generally conical in three-dimensions. There are corresponding detection fields associated with the “a” and “b” sensors. The detection fields are also generally conical in three-dimensions. The sensors “a” and “b” are generally configured to detect movement when an object enters the corresponding detection field, as discussed below.

Referring to FIG. 11, a cross-section top view of an exemplary output field is illustrated for sensors “a”, “b” and “c”. Each sensor generally has an overlap region with one or two other sensors and a region where the measured amplitude is predominantly from one sensor. Referring to FIG. 11, as horizontal movement is detected between the “a”, “b” and “c” sensors from left to right in a horizontal direction, as denoted in FIG. 11, an exemplary curve of output amplitudes associated with the signals versus time for each sensor is depicted in FIG. 12. Likewise, vertical movement from the surface of the electronic equipment 10 to beyond the effective target range of the sensors provides an exemplary curve of amplitude versus time for each of the sensors is illustrated in FIG. 13.

One of ordinary skill in the art will readily appreciate that the characteristic output curve will vary depending on the configuration of the sensors and the detected movement (e.g., horizontal, vertical, diagonal, circular, etc.). For example, referring to FIG. 11, horizontal movement in closer proximity to sensors “a” and “b” results in a higher detected amplitude for sensors “a” and “b” than for the output amplitude detected for sensor “c”, as shown by FIG. 12. If the horizontal movement was centrally applied to all sensors (e.g., “a”, “b” and “c”), the curve representing sensor “c” would have substantially the same amplitude as sensors “a” and “b” in FIG. 12.

With these principles, aspects of the present invention relate to movement detection circuitry 20 having one or more sensors to determine movement of an object near the electronic equipment 10. For example, detecting movement of an associated user's hand and/or object in the x, y and z directions. When multiple sensors used in the movement detection circuitry 20, the amplitude output from the respective sensors (e.g., from sensors “a”, “b” and “c”) will generally be proportional to the distance to a reflecting object and the reflectance from the object itself. Thus, relative distance and type of movement (e.g., vertical, horizontal, diagonal, circular, etc.) is possible to detect and quantify. For example, movements up and down, transversal in any direction, rotations clockwise and counter clockwise are possible to detect. Once the movement is detected, a control signal corresponding to the detected movement can then be used for controlling different functions in the electronic equipment (e.g. sound level, start and stop of an application, scrolling in a menu, making a menu selection, etc.).

The sensors that comprise the movement detection circuitry 20 are generally coupled to an analog to digital converter 75, as shown in FIG. 9. The analog to digital converter 75 converts an analog output signal of the corresponding sensor or sensors to a corresponding digital signal or signals for input into the control circuit 50. The converted signals are made available to other components of the electronic equipment 10 (e.g., an algorithm 56, control circuit 50, memory 54, etc.), for further processing to determine if an object has moved within the range of the sensors and detecting the movement of the object.

In general, a predetermined movement of an object within the effective range of the sensors will generate a corresponding predetermined control signal. The predetermined control signal may vary based upon one or states of the electronic equipment 10. For example, a detected movement when an application (e.g., an audio and/or video player) is being executed may cause a control signal to be generated that skips to the next track of multimedia content being rendered on the electronic equipment. However, the same user movement detected when another application is being executed may generate a control signal that performs a different function (e.g., turn off an alarm that has been triggered, turn off a ringer, send a call to voice mail, etc.), as explained below. Likewise, detected object velocity and/or acceleration may also generate control signals that perform different functions. For example, a slow left to right horizontal movement may trigger a fast forward action, while a faster left to right horizontal movement may trigger a skip to next track function.

The target field associated with each of the sensors of movement detection circuitry 20 is identified by a dashed line emanating from the origin of each sensor in FIGS. 10 and 11. The target field for each sensor is generally in the shape of a cone extending outward from the surface of the sensor. Preferably, the effective range of the sensor is approximately 40 centimeters from the surface of the sensor. The effective range (or distance from the sensor) will vary depending on the precise application of the sensor. For example, a smaller electronic device will generally require a smaller effective distance to operate the device. While a larger device may require a larger effective distance to operate on or more features of the device. One of ordinary skill in the art will readily appreciate that the effective range of a sensor may vary based on a number of parameters, such as for example, sensor type, normal operating range of the sensor, sensor application, power supplied to the light source, parameter being detected, etc.

As shown in FIGS. 3B and 4-8, the housing 23 may include a light source 21 for illuminating an area substantially overlapping the effective range of the sensors. The light source may be any desired light source. An exemplary light source 21 may be a conventional light emitting diode, an infrared light emitting diode or a camera flash. Preferably, the light source 21 has an effective operating range that substantially includes the operating range of the sensors.

In one aspect of the invention, the object (e.g., a user's hand, a pointer, etc.) may be enlightened with light from the light source 21. The light source 21 is preferably modulated with a high frequency (for example 32 kHz) to be able to suppress DC and low frequency disturbances (e.g., the sun and 100/120 Hz from lamps). The reflected modulated radiation (e.g., infrared light) is detected by use input device sensors (e.g., sensors “a”, “b”, and “c”). As stated above, the infrared sensor can be a phototransistor or a photodiode. The sensors should have an opening angle sufficient to give the right spatial resolution with the light source 21, as illustrated in FIG. 10.

The detected signal may be amplified, high pass filtered and amplitude detected before it is fed to an analog to digital converter 75, as shown in FIG. 9. After digitizing the detected signal, the angle associated with the signal may be calculated for each sensor and position and/or movement is determined. By transmitting the modulated light in short bursts at a rate of 20-100 Hz depending on needed resolution energy can be saved. The infrared light emitting diode preferably has an opening angle matching the opening angle (e.g., the angle between opposite sides of the cone) of the sensors, which will generally ensure an optimum use of the emitted light, as discussed above.

As stated above, data from the one or more sensors that comprises the movement detection circuitry 20 is coupled to analog to digital (A/D) converter 75, as shown in FIG. 9. In the idle mode (e.g., when no object is covering one or more of the sensors), an offset value may be measured from the sensor and out to the A/D converter 75. In order to ensure that an object is detected, as opposed to noise or other spurious signals being detected, a threshold voltage may be applied to one or more data signals output from the A/D converter 75. If values are above a certain threshold value, the measured value may be regarded as being active—(i.e., an object has been detected over one or more sensors).

User movement over the sensors that comprise the movement detection circuitry 20 will generally provide different amplitudes and angles from the object (e.g., a user's hand) to the sensor, which can be calculated, as graphically illustrated in FIG. 12.

An angle between two sensors can be calculated as:

$$α = \frac{a - b}{a + b}$$

where “a” and “b” are the output amplitudes from the sensors respectively. As one of ordinary skill in the art will readily that standard trigonometry calculations may be used to calculate vertical and/or horizontal movement over the sensors.

Another exemplary movement detection circuitry 20 is illustrated in FIGS. 3A and 5. The movement detection circuitry 20 illustrated is in the form of an array of sensors. The movement detection circuitry 20 can determine movement in the X, Y and Z axes based on substantially same principles as discussed above. For example, as movement is detected, each of the sensors in the array outputs a corresponding value that can be used to allow tracking of the object. Based upon the start location and velocity, acceleration and/or path of the detected movement a corresponding control signal may be generated to control one or more parameters of the electronic equipment and/or applications.

As indicated above, the movement detection circuitry 20 may also be in the form of a camera that comprises one or more image sensors for taking digital pictures and/or movies. Image and/or video files corresponding to the pictures and/or movies may be temporarily and/or permanently stored in memory 54. In some embodiments, the electronic equipment 10 may include a light source 21 that is a standard camera flash that assists the camera take photographs and/or movies in certain illumination conditions.

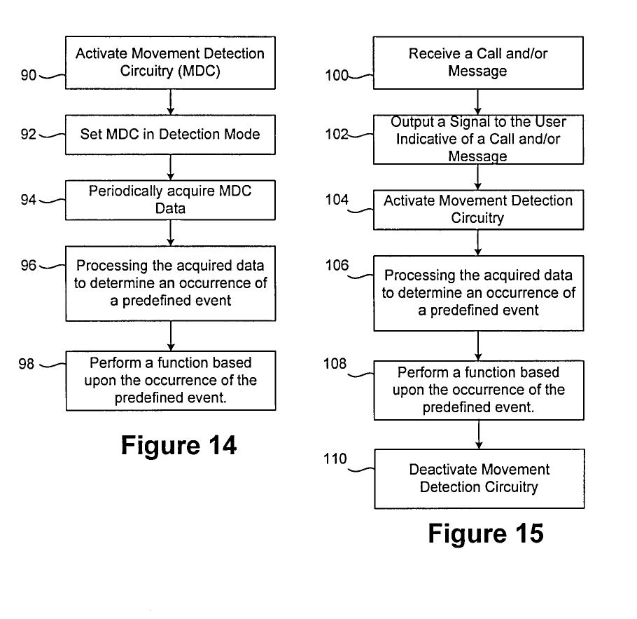

With additional reference to FIG. 14, illustrated is a flow chart of logical blocks that make up certain features the movement detection circuitry 20 in the form of a camera. The flow chart may be thought of as depicting steps of a method. Although FIG. 14 shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 90 by activating the movement detection circuitry 20. As stated previously, the movement detection circuitry 20 may be in the form of a camera and/or other contactless sensor. Activating the movement detection circuitry 20 may be invoked by any desired manner. For example, the movement detection circuitry 20 may be invoked by user action (e.g., such as by pressing a particular key of the keypad 16, closing a clamshell housing of the electronic equipment 10, receiving an incoming call and/or message, triggering of an alarm, etc.), automatically upon sensing predefined conditions of the electronic equipment, the occurrence of internal events (e.g., an alarm being triggered), the occurrence of an external event (e.g., receiving a call and/or message), and/or any other desired manner or triggering event. One of ordinary skill in the art will readily appreciate that the above list of items is exemplary in nature and there may be a wide variety of parameters and/or conditions that activate the movement detection circuitry 20.

Due to power consumption requirements of the movement detection circuitry 20, it may beneficial to conserve power of the electronic equipment to selectively activate the movement detection circuitry 20. This is especially true when the electronic equipment includes portable communication devices that generally have a limited and/or finite power supply (e.g., a battery). In other situations when the electronic equipment is generally always coupled to a power source, the movement detection circuitry 20 may always be activated, if desired.

When the movement detection circuitry 20 is activated, at step 92, the movement detection circuitry 20 is placed in a data detection mode (e.g., an image detection mode) for acquiring images and/or sensor data. In the data detection mode, the movement detection circuitry 20 may be activated to detect movement of an object over the one or more sensors that comprise the movement detection circuitry 20. As discussed in detail below, the image detection circuitry 20 allows a user to control the electronic equipment 20 without actually physically touching the electronic equipment 10, by making a user action (e.g., a gesture) in the field of the image detection circuitry 20. Once the user action is detected, the electronic equipment may perform a function based on the detected user action.

At step 94, the movement detection circuitry periodically acquires data points (e.g., images and/or data) at a predefined time periods. The period of time between acquiring images may be any desirable period of time. The period may be selected from predefined periods of time and/or periods of time set by the user. Preferably, less than 2 second elapses between sequential data points. More preferably, about ¼ second elapses between acquiring sequential data points. If too much time elapses, it may be difficult to detect a predefined user action due to velocity in which the object may be moving over the motion detection circuitry. The data may be temporarily stored in memory until a predefined event occurs.

At step 96, the data is generally processed to determine an occurrence of a predefined event. The data may be processed in any manner to determine whether a predefined event has occurred. For example, two or images and/or data points may be compared to each other to determine if a predetermined event has occurred. In another example, each image and/or data point may be searched for the existence of a predetermined event. The predefined events may be any detectable user action. Suitable user actions include, for example, object movement, horizontal and/or vertical movement, user gestures, hand waving, etc.

At step 98, regardless of the type of movement detection circuitry 20 used, once the predefined user action is detected by any method, a control signal may be generated to control an operation and/or function based on the occurrence of the predefined user action. The function performed may be any function capable of being performed by the electronic equipment and/or the software applications executed by the electronic equipment 10. The following use cases are exemplary in nature and not intended to limit the scope of the present invention.

### EXAMPLE 1

### Reject/Mute Call

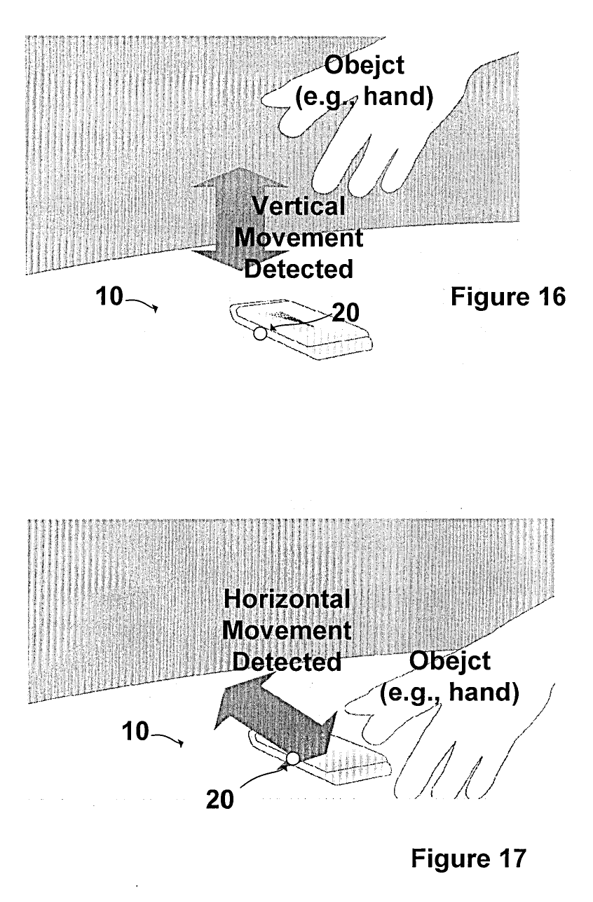

Referring to FIG. 15, at step 100, the electronic equipment receives a call and/or message. At step 102, a signal is output to the associated user to indicate receiving an incoming call and/or message. At step 104, movement detection circuitry 20 is activated. Optionally, a gesture and/or movement control icon may also appear on a display, which is visible to the user to indicate to the user that the movement detection circuitry 20 is active. In addition, one or more light emitting diodes (LEDs) and/or display lights may fade in to illuminate at least a portion of the movement detection circuitry 20. At step 106, a user action is detected based on periodically acquired information from the movement detection circuitry 20. In this embodiment, acquired movement detection data may correspond to an exemplary mute function and/or exemplary reject function. For example, an object (e.g., an associated user's hand) is detected moving downward over the movement detection circuitry 20, as shown in FIG. 16, which ends up touching the electronic equipment and/or covering the movement detection circuitry 20 for a predetermined number of seconds (e.g., approximately 2-3 seconds). In another example, the user action may be a horizontal hand movement (e.g., left to right and/or right to left across the motion detection circuitry 20, as shown in FIG. 17) within a predetermined number of seconds (e.g., approximately 2-3 seconds). At step 108, a control is generated and the call is muted and/or rejected, based on the detected user movement. At step 110, the movement detection circuitry 20 is deactivated. In addition, the optional gesture control icon is no longer displayed on the display and the LEDs may be turned off.

### EXAMPLE 2

### Snooze Alarm

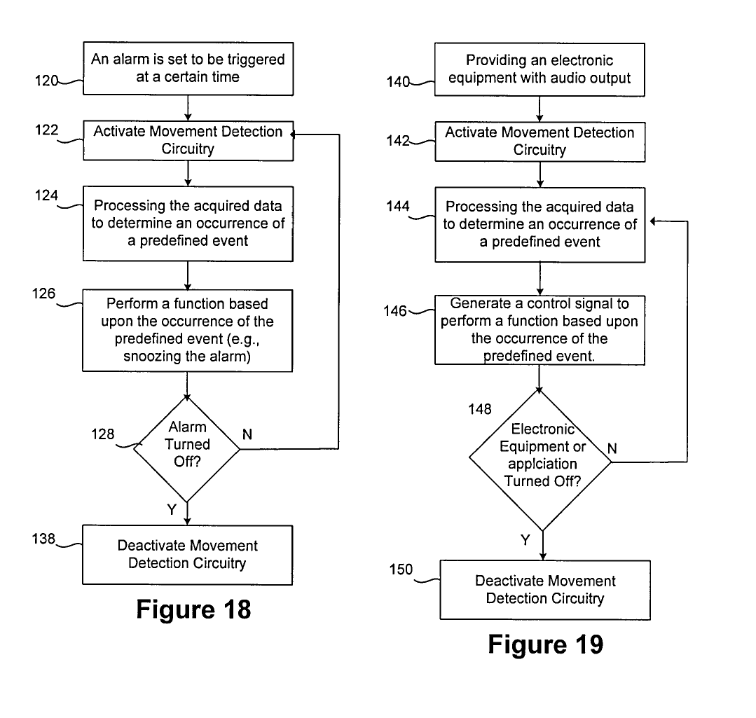

Another exemplary method in accordance with aspects of the invention is illustrated at FIG. 18. Referring to FIG. 18, at step 120, an alarm housed in electronic equipment 10 is set to sound at a certain time. At step 122, movement detection circuitry 20 is activated at the time of the alarm sounds. Optionally, a gesture and/or movement control icon may also appear on a display, which is visible to the user to indicate to the user that the movement detection circuitry 20 is active. In addition, one or more light emitting diodes (LEDs) and/or display lights may fade in to illuminate at least a portion of the movement detection circuitry 20. At step 124, a user action is detected that corresponds to a “snooze” function. The snooze function stops the alarm and sets it to ring again at a short time later, typically anywhere between five and ten minutes. For example, an object (e.g., an associated user's hand) is detected moving downward over the movement detection circuitry 20, which ends up touching the electronic equipment and/or covering the movement detection circuitry 20 for a predetermined number of seconds (e.g., approximately 2-3 seconds), as shown in FIG. 16. In another example, the user action may be a horizontal hand movement (e.g., left to right and/or right to left across the motion detection circuitry 20 within a predetermined number of seconds (e.g., approximately 2-3 seconds), as shown in FIG. 17. At step 126, a function is performed based upon the occurrence of the predefined event. For example, the alarm fades out and the LEDs may also be turned off. At step 128 a determination is made to see if the alarm is turned off or “snoozed”, if the alarm is “snoozed” sequences 122 to 128 are repeated until the alarm is eventually turned off by the associated user. At step 130, once the alarm is turned off, the movement detection circuitry 20 is deactivated. In addition, the optional gesture control icon is no longer displayed on the display and the LEDs may be turned off.

### EXAMPLE 3

### Adjust Volume

The volume of an audio signal output from the electronic equipment and/or an external speaker and/or device coupled to the electronic equipment may also be controlled by detecting an object moving in the field of the movement detection circuitry 20. In this example, it is assumed that the electronic equipment is outputting an audio stream through a speaker. The speaker may be internal to the electronic equipment or external to the electronic equipment. Referring to FIG. 19, at step 140, an electronic equipment 10 is provided that outputs audio through a speaker. Upon activation of the audio output, at step 142, movement detection circuitry 20 is activated. Optionally, a gesture and/or movement control icon may also appear on a display, which is visible to the user to indicate to the user that the movement detection circuitry 20 is active. In addition, one or more LEDs and/or display lights may fade in to illuminate at least a portion of the movement detection circuitry 20. At step 144, a user action is detected that corresponds to a predefined event from periodically acquired data from the movement detection circuitry. At step 146, a control signal is generated that corresponds to a function and/or operation to be performed based upon the detected movement. For example, as shown in FIG. 16, when an object is detected moving downward over the movement detection circuitry 20, the volume may decrease. If the object ends up touching the electronic equipment and/or covering the movement detection circuitry 20 for a predetermined number of seconds (e.g., approximately 2-3 seconds), the application causing the output of the audio stream may be terminated, as discussed in detail below. In another example, if the object is detected moving upward the volume may be increased. In another example, the user action may be a horizontal hand movement (e.g., left to right and/or right to left) across the motion detection circuitry 20 within a predetermined number of seconds (e.g., approximately 2-3 seconds) to mute the sound from the speaker, as shown in FIG. 17. In another embodiment, the object may be moved in a clockwise direction to increase the volume and/or counter-clockwise direction to decrease the volume. At step 148, once the application that is controlling the volume and/or playing the multimedia content is turned off and/or the electronic equipment is turned off, the movement detection circuitry 20 may be deactivated, as stated at step 150; otherwise steps 144-148 may be repeated. In addition, the optional gesture control icon on the display may also be turned off.

### EXAMPLE 4

### Touch to Off

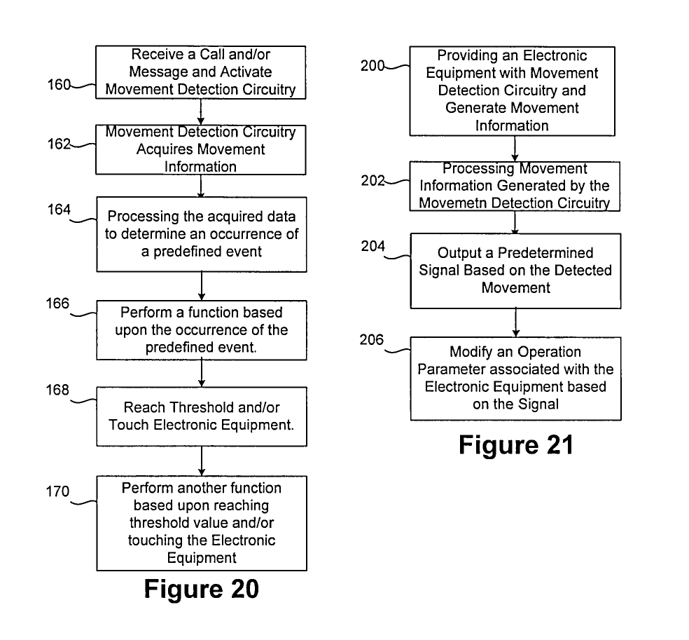

Another aspect of the present invention is directed to a combination movement detection and touch-to-off functionality, as illustrated in FIG. 20. Referring to FIG. 20, at step 160, when an electronic equipment 10 is receiving an incoming call, the movement detection circuitry may be activated. At step 162, the movement detection circuitry acquires movement information. At step 164, the movement information is processed to determine if the movement information corresponds to a predefined user movement. At step 166, if a predefined event occurs, a function and/or operation is performed based on the occurrence of the predefined event. For example, the user may position their hand above the movement detection circuitry 20 and move his or her hand closer to the sensors, which may lower the volume of the ring. At step 168, upon reaching a predetermined threshold value, further movement of the user's hand toward the electronic equipment 10 (before or after contact with the electronic equipment is made) will cause another function to be performed based upon the reached threshold and/or touching of the electronic equipment by the object. For example, upon reaching the threshold value and/or contact with the electronic equipment, the call may be muted and/or forwarded to voice mail or some other user defined feature activated. Likewise, if the electronic equipment is functioning as an alarm clock and the alarm has been triggered, movement of an object in an up to down fashion over the sensors may correspond to a command that decreases the volume and eventually turns off the alarm before and/or after the user's hand actually touches the electronic equipment 10. In either case, the volume of the ringer and/or the alarm may be lowered to a point where the device is programmed to turn off and/or the user's hand may actually touch a touch sensor associated with the electronic device to turn off the ringer and/or alarm.

One of ordinary skill in the art will readily appreciate that the above examples are illustrative of aspects of the present invention. Other aspects of the present include, for example: correlating a predefined hand movement over the movement detection circuitry 20 of the electronic equipment to call, send a message and/or otherwise initiate a sequence of processes and/or steps to contact an individual and/or group. For example, contact A, may be associated with an object (e.g., a user's hand) making a circular movement over the movement detection circuitry 20. When the movement of the object is detected, a control signal may be generated that causes the electronic equipment to perform a predetermined function and/or process (e.g., call the individual associated with the circular movement).

One of ordinary skill in the art will also readily appreciate that other movements may also be used to initiate an action by the electronic equipment. For example, movement in the shape of a square, rectangle, oval, diamond, line or any polygon may be programmed to perform a specific function.

In addition to position data being detected by the movement detection circuitry 20, other parameters and/or information (e.g., velocity, acceleration, moments, etc.) may also be detected and used by the electronic equipment 10 for processing. For example, vertical and/or horizontal movement detected by the movement detection circuitry 20 may be configured to cause a first predetermined response when the vertical movement has a first velocity (e.g., a velocity below a threshold) and a second response if the vertical movement has a faster velocity (e.g., a velocity detected above a threshold).

Likewise, when the movement detection circuitry 20 detects an object moving away from the electronic equipment at a rate slower than a first predetermined threshold rate, a control signal may be generated that causes the volume associated with an output of the electronic equipment to increase at a first predetermined rate. When the user input circuitry detects an object moving away from the electronic equipment at a rate faster than the first predetermined threshold rate, a control signal may be generated that causes the volume associated with an output of the electronic equipment to increase at a second predetermined rate, wherein the second predetermined rate is faster than the first predetermined rate.

In another example, when the movement detection circuitry detects an object substantially stationary for a predetermined amount of time and the electronic equipment is in the power save mode, a control signal may be generated that activates the electronic equipment from the power save mode.

In another example, when the movement detection circuitry detects an object moving in a diagonal path across the movement detection circuitry in at least one of a horizontal and/or vertical plane, a predetermined control signal may be generated to control an application and/or process of the electronic equipment. Likewise, when the movement detection circuitry detects an object moving in a circular pattern, a predetermined control signal may be generated to control an application and/or process of the electronic equipment.

In addition to detecting movement of an object (e.g., a user's hand), the movement detection circuitry 20 may also detect movement of individual digits of an associated user's hand and/or a plurality of objects (e.g., hands within the range of movement detection circuitry. Upon such detection, a control signal may be generated to control an application and/or process of the electronic equipment.

According to aspects of the present invention, it is possible for the user to enter new user actions into a library of predefined user actions. There are a variety of methods for training the system to recognize a new user action. All such methods fall with in the scope of the present invention. One process for training is through training the system to recognize a predefined movement of an object. For example, in one embodiment, samples of the new user action are taken. The images are associated with a particular user action and stored. Another method includes providing samples of the new user action performing the user action in the field of the movement detection circuitry 20 a certain number of times. This, naturally, requires some user intervention. In a preferred embodiment, the user or users perform the new user action about 10 times. The number of users and the number of samples have a direct bearing on the accuracy of the model representing the user action and the accuracy of the statistics of each key point. In general, the more representative samples provided to the system, the more robust the recognition process will be. In one embodiment, a number of key points in the user action are identified and entered. For example, a user action that comprises a “circular” motion, the object making the circular motion may be repeatedly made over the movement detection circuitry 20. The time and position of the points may then be identified and associated with a particular function to be performed when the object movement has determined.

The movement detection circuitry may further include a microphone 24 to detect an audible signal from the object moving within the effective range of the movement detection zone. Such audible signals may originate from any source. Exemplary sources of audible signals in accordance with aspects of the present invention include: a user's hands clapping, fingers snapping, voice, etc.

The movement detection circuitry 20 is capable of providing one or more signals to the processor 52 (shown in FIG. 9), wherein the signals are indicative of movement and/or location of an object in the target area. The movement detection circuitry 20 may provide separate signals for the location signal for each sensor and/or combine the signals in or more composite signal. Preferably, location and time data is collected in order to determine movement, velocity and/or acceleration of an object (e.g., a user's hand) in the target area.

The object to be measured may be any suitable object. Suitable objects include, for example, an associated user's hand, one or fingers, multiple hands, a stylus, pointer, a pen, a gaming controller and/or instrument, surface, wall, table, etc. The movement signals (also referred to herein as location signals) may be measured directly and/or indirectly. In one aspect of the present invention, the signals are processed indirectly in order to determine movement information, velocity, and/or acceleration.

Referring to FIG. 9, the processor 52 processes the signals received from the movement detection circuitry 20 in any desirable manner. The processor 52 may work in conjunction with the application software 56 and/or other applications and/or memory 54 to provide the functionality described herein.

The electronic equipment 10 includes a primary control circuit 50 that is configured to carry out overall control of the functions and operations of the electronic equipment 10. The control circuit 50 may include a processing device 52, such as a CPU, microcontroller or microprocessor. The processing device 52 executes code stored in a memory (not shown) within the control circuit 50 and/or in a separate memory, such as memory 54, in order to carry out operation of the electronic equipment 10. The processing device 52 is generally operative to perform all of the functionality disclosed herein.

The memory 54 may be, for example, a buffer, a flash memory, a hard drive, a removable media, a volatile memory and/or a non-volatile memory. In addition, the processing device 52 executes code to carry out various functions of the electronic equipment 10. The memory may include one or more application programs and/or modules 56 to carry out any desirable software and/or hardware operation associated with the electronic equipment 10.

The electronic equipment 10 also includes conventional call circuitry that enables the electronic equipment 10 to establish a call, transmit and/or receive E-mail messages, and/or exchange signals with a called/calling device, typically another mobile telephone or landline telephone. However, the called/calling device need not be another telephone, but may be some other electronic device such as an Internet web server, E-mail server, content providing server, etc. As such, the electronic equipment 10 includes an antenna 58 coupled to a radio circuit 60. The radio circuit 60 includes a radio frequency transmitter and receiver for transmitting and receiving signals via the antenna 58 as is conventional. The electronic equipment 10 generally utilizes the radio circuit 60 and antenna 58 for voice, Internet and/or E-mail communications over a cellular telephone network. The electronic equipment 10 further includes a sound signal processing circuit 62 for processing the audio signal transmitted by/received from the radio circuit 60. Coupled to the sound processing circuit 62 are the speaker 22 and microphone 24 that enable a user to listen and speak via the electronic equipment 10 as is conventional. The radio circuit 60 and sound processing circuit 62 are each coupled to the control circuit 50 so as to carry out overall operation of the electronic equipment 10.

The electronic equipment 10 also includes the aforementioned display 14, keypad 16 and movement detection circuitry 20 coupled to the control circuit 50. The electronic equipment 10 further includes an I/O interface 64. The I/O interface 64 may be in the form of typical mobile telephone I/0 interfaces, such as a multi-element connector at the base of the electronic equipment 10. As is typical, the I/O interface 64 may be used to couple the electronic equipment 10 to a battery charger to charge a power supply unit (PSU) 66 within the electronic equipment 10. In addition, or in the alternative, the I/O interface 64 may serve to connect the electronic equipment 10 to a wired personal hands-free adaptor, to a personal computer or other device via a data cable, etc. The electronic equipment 10 may also include a timer 68 for carrying out timing functions. Such functions may include timing the durations of calls, generating the content of time and date stamps, etc.

The electronic equipment 10 may include various built-in accessories, such as a camera 70, which may also be the movement detection circuitry 20, for taking digital pictures. Image files corresponding to the pictures may be stored in the memory 54. In one embodiment, the electronic equipment 10 also may include a position data receiver (not shown), such as a global positioning satellite (GPS) receiver, Galileo satellite system receiver or the like.

In order to establish wireless communication with other locally positioned devices, such as a wireless headset, another mobile telephone, a computer, etc., the electronic equipment 10 may include a local wireless interface adapter 72. The wireless interface adapter 72 may be any adapter operable to facilitate communication between the electronic equipment 10 and an electronic device. For example, the wireless interface adapter 50 may support communications utilizing Bluetooth, 802.11, WLAN, Wifi, WiMax, etc.

Movement of an object may be detected in a variety of ways. For example, there may be one or more methods to detect movement of an object moving horizontally and/or vertically across one or more of the sensors. Referring to FIG. 21, an exemplary method in accordance with one aspect of the present invention is illustrated. The method provides a method for detecting movement near an electronic equipment. At step 200, the method includes providing an electronic equipment 10 including movement detection circuitry (e.g., an optical sensor (e.g., a camera), sensors “a”, “b” and “c”, etc.) disposed within a housing, wherein the movement detection circuitry detects a movement near the electronic equipment and outputs corresponding movement information. At step 202, the processor processes the movement information received from the movement detection circuitry and generates a control signal based at least in part on the one or more signals received from the movement detection circuitry. At step 204, a predetermined output signal is generated based upon the detected movement. At step 206, an operating parameter associated with the electronic equipment and/or application being executed on the electronic equipment is changed or otherwise modified. The control signal is capable of controlling one or more aspects of the electronic equipment and/or applications executed by the electronic equipment 10, as discussed above.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. An electronic equipment comprising:
movement detection circuitry configured to detect movement of an object near the movement detection circuitry, wherein the movement detection circuitry includes at least one sensor and generates at least one output signal corresponding to a position of the object detected;
a processor coupled to the movement detection circuitry, wherein the processor receives one or more signals from the movement detection circuitry and outputs a control signal based at least in part on the one or more signals detected by the movement detection circuitry.

2. The electronic equipment of claim 1, wherein the movement detection circuitry is a camera.

3. The electronic equipment of claim 2, wherein the sensors are image sensors.

4. The electronic equipment of claim 3, wherein the sensors are at least one selected from the group consisting of: charge-coupled devices (CCD) or complementary metal-oxide-semiconductor (CMOS) sensors.

5. The electronic equipment of claim 1 further including a memory coupled to the processor for storing the at least one output signal corresponding to the detected movement of the object.

6. The electronic equipment of claim 5 further including a movement detection algorithm in the memory for determining movement information corresponding to the position of the object detected by the movement detection circuitry.

7. The electronic equipment of claim 6, wherein the movement detection algorithm compares the at least one output signal from the movement detection circuitry at a first time period and the at least one output signal from the movement detection circuitry at a second time period.

8. The electronic equipment of claim 7, wherein the output signal from the first and second time period is in the form of image data.

9. The electronic equipment of claim 3 further including a housing that houses the processor and at least a portion of the movement detection circuitry.

10. The electronic equipment of claim 9, wherein the at least one sensor is located on an outer surface of the housing.

11. The electronic equipment of claim 1, wherein the movement detection circuitry includes a plurality of sensors.

12. The electronic equipment of claim 11, wherein at least one of the sensors is an infrared sensor.

13. The electronic equipment of claim 12, wherein the movement detection circuitry detects movement in a target field near the electronic equipment.

14. The electronic equipment of claim 11 further includes a memory coupled to the processor for storing the at least one output signal corresponding to the detected movement of the object.

15. The electronic equipment of claim 14 further including a movement detection algorithm in the memory for determining movement information corresponding to the position of the object detected by the movement detection circuitry.

16. The electronic equipment of claim 15, wherein the movement detection algorithm compares the at least one output signal from the movement detection circuitry at a first time period and the at least one output signal from the movement detection circuitry at a second time period.

17. The electronic equipment of claim 11 further including a housing that houses the processor and at least a portion of the movement detection circuitry.

18. The electronic equipment of claim 8, wherein the at least one sensor is located on an outer surface of the housing.

19. A method for detecting movement near an electronic equipment, the method comprising:
providing an electronic equipment including movement detection circuitry disposed within a housing, wherein the movement detection circuitry detects a movement of an object near the electronic equipment and outputs movement information;
processing the movement information received from the movement detection circuitry to generate a control signal based at least in part on the one or more signals received from the movement detection circuitry to control one or more operations of the electronic equipment.

20. The method of claim 19, wherein the movement detection circuitry is a camera.

21. The method of claim 20, wherein the sensors are image sensors.

22. The method of claim 20, wherein the movement detection circuitry detects a predetermined movement of the object in a target field.

23. The method of claim 22, wherein a predetermined output signal is generated based upon a predetermined detected movement.

24. The method of claim 23, wherein the predetermined detected movement includes an object moving vertically downward towards the movement detection circuitry.

25. The method of claim 24, wherein the vertically downward movement corresponds to generating an output signal to perform at least one function from the group consisting of: decreasing a ring volume associated with an incoming call, reducing volume of a speaker associated with the electronic equipment, or generating a mute operation to mute a ring volume associated with an incoming call, message and/or alert.

26. The method of claim 23, wherein the predetermined detected movement includes an object moving vertically upward from the movement detection circuitry.

27. The method of claim 26, wherein the vertically upward movement corresponds to generating an output signal to perform at least one function from the group consisting of: increasing a ring volume associated with an incoming call or increasing a volume of a speaker associated with the electronic equipment.

28. The method of claim 23, wherein a vertical movement detected by the movement detection circuitry causes a first response when the vertical movement has a first speed and a second response if the vertical movement has a faster relative speed than the first speed.

29. The method of claim 23, wherein a horizontal movement detected by the movement detection circuitry causes a first response when the horizontal movement has a first speed and a second response if the horizontal movement has a faster relative speed than the first speed.

30. The method of claim 19, wherein a horizontal movement of the object across the electronic equipment detected by the movement detection circuitry controls a snooze alarm function when an alarm is set off.

31. The method of claim 19, wherein a horizontal movement of the object across the electronic equipment detected by the movement detection circuitry causes the electronic equipment to skip forward to the next track or backward to the previous track when multimedia content is playing on the electronic equipment depending on detected movement.

32. The method of claim 19, wherein when the movement detection circuitry detects an object substantially stationary for a predetermined amount of time and the electronic equipment is in the power save mode, a control signal is generated that activates the electronic equipment from the power save mode.

33. The method of claim 19, wherein the movement detection circuitry is a plurality of sensors.

34. The method of claim 33, wherein at least one of the sensors is an infrared sensor.

35. The method of claim 19, wherein the movement detection circuitry detects movement in a target field.

36. A computer program stored on a machine readable medium in an electronic equipment, the program being suitable for processing information received from movement detection circuitry to determine movement of an object on near the electronic equipment wherein when the movement detection circuitry determines movement of an object near the electronic equipment, a control signal is generated based at least in part on the detected movement of the object.
